(19) United States
(12) Patent Application Publication
(10) Pub. No.: US 2005/0108550 A1
(43) Pub. Date: May 19, 2005

(54) Method for administering presence information in a telecommunication and/or data network

(76) Inventor: Rudolf Stelzl, Dachau (DE)

Correspondence Address: Siemens Corporation;Intellectual Property Department, 170 Wood Avenue South, Iselin, NJ, 08830, US

(21) Appl. No.: 10/500,413

(22) PCT Filed: Dec. 6, 2002
(86) PCT No.: PCT/DE02/04499

(30) Foreign Application Priority Data
Dec. 27, 2001 (DE) 101 64 208.3

(51) Int. Cl. H04K 1/00

(52) U.S. Cl. 713/184; 713/201

(57) ABSTRACT

A method for administering presence information in a telecommunication and/or data network, especially for performing a service based on presence information. Administration data for an administration process is inputted vocally or inputted by voice recognition or a PIN is keyed in or inputted in a predefined short message format or at an IP-based interface, outside an SIP method, and is subsequently converted into an SIP-compliant format in order to carry out said administration process

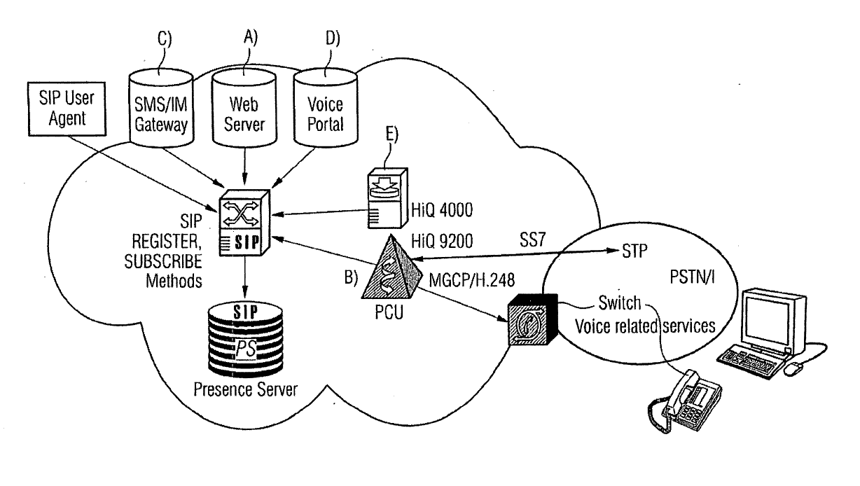

### CROSS REFERENCE TO RELATED APPLICATIONS

This application is the US National Stage of International Application No. PCT/DE02/04499 filed Dec. 6, 2002 and claims the benefit thereof. The International Application claims the benefit of German application No. 10164208.3 filed Dec. 27, 2001, both of the applications are incorporated by reference herein in their entirety.

### FIELD OF INVENTION

The invention relates to a method for administering presence and/or availability information in a telecommunication and/or data network.

### BACKGROUND OF INVENTION

For many years, in both telecommunication networks—the fixed network as well as mobile networks—and also in data networks—the Internet as well as Intranets—increasing numbers of IN services have been provided and used which are based on information about the presence or availability of a subscriber and will be referred to in this document as “presence-based services”.

Presence-based services will have a significantly enhanced role to play in Next-Generation Networks (NGN). For presence-based services/applications information about the availability of subscribers (how and where a subscriber can be reached) is utilized for the service/the application. This information can typically serve to signal to a subscriber whether and how the other party that they wish to call can be reached so that, if their availability status changes, a connection can then be set up automatically for example, to optimize call forwarding or call diversion scenarios or to initiate conferences if all desired subscribers are identified as accessible.

To allow meaningful use of the services the following functions must be available:
1) A subscriber must be able to define information about their own presence status.
2) The subscriber must be able at any time to define the group of people who are allowed access to their presence information (e.g. all persons who are listed in their Outlook contact addresses or all subscribers in a closed user group).
3) The subscriber must be able to subscribe to notifications about the presence status of another subscriber or of a specific service (e.g. to be given information as soon as subscriber X is present).
4) The subscriber must be able to be informed about the occurrence of their desired conditions (of a previously defined state) (e.g. subscriber X has changed to the “present” state).

In the area of telecommunications the user normally enters these functions at a graphical user interface on a PC or handheld. An SIP UserAgent on the terminal then converts this information into the corresponding SIP methods: “REGISTER”, to define one's own presence status and the access rights; “SUBSCRIBE” to give notification that you wish to be informed about the presence status of a specific subscriber; “NOTIFY” is finally the information that the desired subscriber has assumed the subscribed presence status. As a rule this information is sent to what is known as a presence server which then initiates the corresponding functions, e.g. storage of the REGISTER information or output of NOTIFY once the condition defined by SUBSCRIBE is fulfilled.

It should thus be emphasized that previously the presence information has as a rule been administered via an SIP-based terminal of the subscriber and is thus only available to SIP subscribers. This represents a significant restriction of the user group which is neither in the interests of potential users nor of service providers (who naturally wish to reach as many users as possible).

### SUMMARY OF INVENTION

The object of the invention is thus to provide an improved method based on the generic art which allows a significant expansion of users of presence-based services and thus of their scope and usage options.

This object is achieved by methods according to the claims.

The “short message service” mentioned in the claims is a technical term known in the field of telecommunication. For example it can mean an alphanumeric sequence of characters which can be transmitted from a mobile station to a further mobile station or from a mobile station to a mobile network or to any telecommunication network or to any device or computer or server. For example it can be a SMS or MMS as e.g. defined in GSM or 3G or other standards that are e.g. available at www.etsi.org.

The invention includes the fundamental idea of providing a connection, both for entry of the presence status and also for access to the information and service features derived from it, through the interfaces which have not previously been able to be used in this context.

### BRIEF DESCRIPTION OF THE DRAWING

A number of alternatives are described below for how presence information can be administered by any given subscriber or how any given subscriber can be informed when the condition that they require arises. The single FIGURE thus presents a schematic, synoptic presentation of variants A) to E) discussed below in a network structure in which presence information is administered using SIP methods on a presence server and which has various administration interfaces and format conversion options. The FIGURE is largely self-explanatory when related to the explanations of variants A) to E) given below, rendering a specific description of the FIGURE superfluous.

### DETAILED DESCRIPTION OF INVENTION

The functions 1), 2) and 3) listed at the start can therefore be administered by any given subscriber (PSTN/ISDN, H.323, SIP) via the following paths:

A) Administration via Web interface (HTTPS)

The Web interface can either be provided directly by the presence server (internal interface between Web-Interface and Presence-Service) or via a separate Web servers which then in turn converts information administered at the Web interface to the known SIP methods.

B) Entry via PIN codes

With classic PSTN/ISDN telephones the services are controlled in many cases via PIN codes. The subscriber dials a prespecified number and then controls their service (e.g. call diversion for mobile telephones) via a specified key combination (e.g. *1234#).

Similarly specific key sequences can be used to set one's own presence status or, by entering letters (in a similar ways to the way in which telephone directories are used with mobile or cordless telephones) to define the subscribers for which there is to be a subscription or to define restrictions.

The PIN codes are either converted directly in the presence server (e.g. if this has a PSTN/ISDN or H.323 interface) or they are converted in a PSTN/ISDN SIP gateway to the corresponding SIP methods. A conversion into the INFO methods defined in SIP is possible. In this case the presence servers must in its turn convert the PIN codes into the corresponding presence information.

C) Entry via SMS

The presence information can be defined via a predefined structure of an SMS or via keywords (e.g. PS (for Presence Status)=present; PS=not present; Sub (for Subscribe)=Rudi Stelzl or Sub=+49 89 722 23693). the SMS is then sent via a specified number.

Similarly to A) and B) this information can go directly to the presence server which performs the conversion, or the information can be converted on a separate server into the corresponding messages. Mapping of the SMS to an Instant Messaging message is also possible. In this case the presence server must again convert the information.

D) Entry via speech using a voice portal

The subscriber dials the number of the voice portal and can control the voice information via voice dialog (e.g. the voice input “I can be contacted in the office between 14:00 and 16:00.” could be converted into a presence status: Office; this status would be valid in the period between 14:00 and 16:00). The “Automatic-Speech Recognition” function of the Voice Portal can use keyword spotting to filter out the essential information and the Voice Portal can forward this information (as described under A) ) via an “internal interface” to the presence server or convert it to the corresponding SIP methods and transmit it to the presence server.

E) Conversion of information available indirectly into presence status

Indirect information (i.e. information not directly controlled by the subscriber) can also be used to control the presence information. E.g. a subscriber, when making a telephone call from their office, is all likelihood still going to be available at their desk once they have finished the call. Using “In-like” triggers an exchange can forward this information to a presence server. In this case it makes sense for the presence status to change automatically after a selectable time (e.g. 15 minutes) back to the status “not accessible” if there has not been any further status change or refreshing of the status “accessible” (by a further telephone call).

Further examples of obtaining presence information indirectly are subscriber activities such as:—Dialing into the Internet, —Sending e-mails,—Keyboard entries at the PC.

It is also possible to obtain information from contact systems (e.g. Outlook). A few of these options are certainly questionable from the point of view of data security, but could always very well be used on the basis of company-internal regulations or with the agreement of those involved.

For the function 4) described above there are the following alternatives:

F) SMS/Instant Messaging

The subscriber is sent an SMS or an instant message as soon as the desired status has been reached.

G) Announcement (standard announcement or individual announcement)

For PSTN/ISDN and H.323 in particular, which indeed cannot receive an SIP-NOTIFY message directly, the presence server can forward the desired information to a Voice Portal, which sets up a call and plays a standard announcement or an announcement defined previously by the subscriber to provide information about the presence status.

H) Specialized servers

The fact that the desired status has been reached can also be notified to a server which then automatically initiates a call between the two subscribers or even a conference.

I) Visual or audible indication

The fact that the desired status has been achieved can also be indicated visually or audibly. The subscriber can then if necessary request more detailed information by calling a specific number. This makes sense above all if they have subscribed for a number of subscribers.

J) Pop-up window on the PC

In addition it is proposed that the methods shown under F) to I) (or other methods as well) do not necessarily have to be defined a priori. The presence servers can select the method on the basis of the presence information of the subscriber (who has executed the SUBSCRIBE) and thereby achieve a higher likelihood of being reached.

If for example the subscriber is not at their desk but is in a meeting, an SMS or an instant message is more advantageous than an announcement since the latter cannot be accepted.

1-7. (canceled)

8. A method for administrating presence information in a network, the method comprising:
entering administration data for an administration process; and
converting subsequently the administration data to an SIP-conformant format to execute the administration process.

9. The method according to claim 8, wherein
the network is a telecommunication network and/or a data network.

10. The method according to claim 8, wherein
the method is used for implementing a service based on the presence information.

11. The method according to claim 8, wherein
the administration data is entered by voice input and recognition.

12. The method according to claim 8, wherein
entering the administration data is accomplished by keypad entry.

13. The method according to claim 8, wherein
entering the administration data is accomplished by voice input and recognition or by keypad entry of a PIN code.

14. The method according to claim 8, wherein
the administration data is entered within a predefined short message framework.

15. The method according to claim 8, wherein
the administration data is entered at an IP-based interface.

16. The method according to claim 8, wherein
the administration data is entered outside a SIP method.

17. The method according to claim 8, wherein the administration process comprises:
updating presence information.

18. The method according to claim 8, wherein the administration process comprises:
defining a group of a subscribers who can access the presence information.

19. The method according to claim 8, wherein the administration process comprises:
subscribing to presence information of another subscriber or to service based on the presence information.

20. A method for administrating presence information in a network, wherein the method comprises:
feeding administration data in from an external information system for a change of the presence status without active input by the subscriber whose presence status is administered; and
converting the administration data subsequently into an SIP-conformant format for executing the change to the presence status.

21. The method according to claim 20, wherein
the method is used for implementing a service based on the presence information.

22. The method according to claim 20, wherein
the network is a data network and/or a telecommunication network.

23. A method for administration of presence information in network, wherein the method comprises:
outputting output data, arising within the framework of an administration process, by speech synthesis and output or by text output in a predefined short message frame or of an instant message or by optical or acoustic signaling or via a pop-up window at a data terminal, in which case a conversion is undertaken, before output from an SIP-conformant primary format, into a secondary format suitable for an output mode.

24. The method according to claim 23, wherein
the administration process involves information about a change of the presence status of a prespecified subscriber.

25. The method according to claim 23, wherein
the network is a telecommunication network and/or a data network..

26. The method according to claim 23, wherein
the method is used for implementing a service based on the presence information.
